(19) United States
(12) Patent Application Publication
(10) Pub. No.: US 2008/0095172 A1
(43) Pub. Date: Apr. 24, 2008

(54) SYSTEMS AND METHODS FOR SETTING NETWORK CONFIGURATION AND ACCESSING NETWORK

(76) Inventors: Jain-Li Lai, Taipei City (TW); Chin-Li Chu, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/552,149

(22) Filed: Oct. 24, 2006

(51) Int. Cl. H04L 12/56

(52) U.S. Cl. 370/395.6

(57) ABSTRACT

A system for accessing the network is disclosed. The system includes a network communication device and a network terminal. The network communication device is coupled to the network for communicating with the network. The network communication device has a management module for outputting a network address information of the network communication device in response to a specific request. The network terminal is coupled to the network communication device for issuing the specific request to request the network address information of the network communication device and then utilizing the network address information of the network communication device to communicate with the network communication device for accessing the network.

### BACKGROUND OF THE INVENTION

1. Field of the Invention

The invention relates to a system for accessing a network and a method thereof, and more specifically relates to a system for issuing a specific request to request network address information of a network communication device (e.g. a network security appliance) and then utilizing the network address information of the network communication device to communicate with the network communication device for accessing the network, and a method thereof.

2. Description of the Prior Art

The development of networking technology has led to the convenience of mobile computers being able to connect with a network at different places in the world. Network Security Appliance (NSA) is a router which guarantees mobile computers and network safety. NSA is designed to be set in different network systems to satisfy the needs of mobile device users, especially for those users who do not stay in one place for a long time. The following is given as an example. When a user of NSA is on a business trip, he may first set the NSA in his hotel, where the Internet server provides protocol over ethernet (POE) service. Next day, when he goes to a client's office to make business deals, he needs to set the NSA in the client's office where the Internet server provides dynamic host configuration protocol (DHCP) service. If the user uses conventional NSA, he needs to determine the characteristics of the local Internet system first and then reset the network configuration adapted to the currently available Internet communication protocol. In addition, the user needs to remember the IP address of the NSA, so that he can use a browser to reset the NSA.

### SUMMARY OF THE INVENTION

It is therefore an object of the present invention to provide systems and related methods for accessing a network quickly and easily.

According to an aspect of the present invention, a system for accessing a network is disclosed. The system comprises a network communication device and a network terminal. The network communication device is coupled to the network for communicating with the network. The network communication device comprises a management module for outputting a network address information of the network communication device in response to a specific request. The network terminal is coupled to the network communication device for issuing the specific request to request the network address information of the network communication device and then utilizing the network address information of the network communication device to communicate with the network communication device for accessing the network.

According to another aspect of the present invention, a system for setting a network configuration is disclosed. The system comprises: a network communication device, coupled to a network, for communicating with the network. The network communication device comprises a network environment detector for issuing at least a discover packet to detect if the network communication device is coupled to a specific network environment before a network configuration of the network communication device for communicating with the network is set.

According to yet another aspect of the present invention, a method for configuring a system having a network communication device and a network terminal is disclosed. The network terminal is coupled to a network through the network communication device. The method comprises: issuing a specific request to request a network address information of the network communication device; utilizing the network communication device to output the network address information of the network communication device in response to the specific request; and utilizing the network terminal to communicate with the network communication device for accessing the network according to the network address information of the network communication device.

According to yet another aspect of the present invention, a method for setting a network configuration is disclosed. The method comprises: utilizing a network communication device to communicate with the network; and utilizing a network environment detector for issuing at least a discover packet to detect if the network communication device is coupled to a specific network environment before a network configuration of the network communication device for communicating with the network is set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system for accessing a network according to an embodiment of the present invention.

FIG. 2 is a flowchart illustrating a method employed by the system shown in FIG. 1 for accessing the network.

FIG. 3 is a flowchart illustrating an operation of configuring the network communication device shown in FIG. 1.

### DETAILED DESCRIPTION

Please note that certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

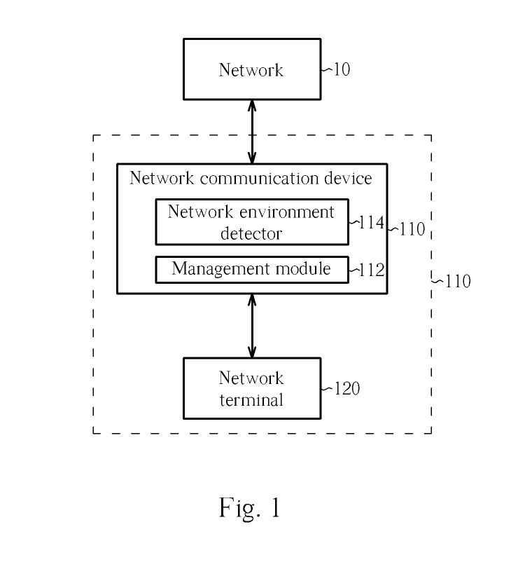

Please refer to FIG. 1. FIG. 1 is a block diagram of a system 100 for accessing a network 10 according to an embodiment of the present invention. As shown in FIG. 1, the system 100 includes a network communication device 110 and a network terminal 120 (e.g. a laptop computer). The network communication device 110 is coupled to the network 10 for communicating with the network 10 (i.e. the Internet). In this embodiment, the network communication device 110 is a network security appliance. However, this is not meant to be a limitation of the present invention. The network communication device 110 comprises a management module 112 and a network environment detector 114, where the management module 112 is for outputting a network address information in response to a specific request, and the network environment detector 114 is coupled to the network terminal 120 for issuing at least a discover packet to detect if the network communication device 110 is coupled to a specific network environment before a network configuration of the network communication device 110 for communicating with the network 10 is set. The network terminal 120 is coupled to the network communication device 110 for issuing the specific request to request the network address information of the network communication device 110 and then utilizing the network address information of the network communication device 110 to communicate with the network communication device 110 for accessing the network 10. Operations of the network communication device 110 and the network terminal 120 are detailed as below.

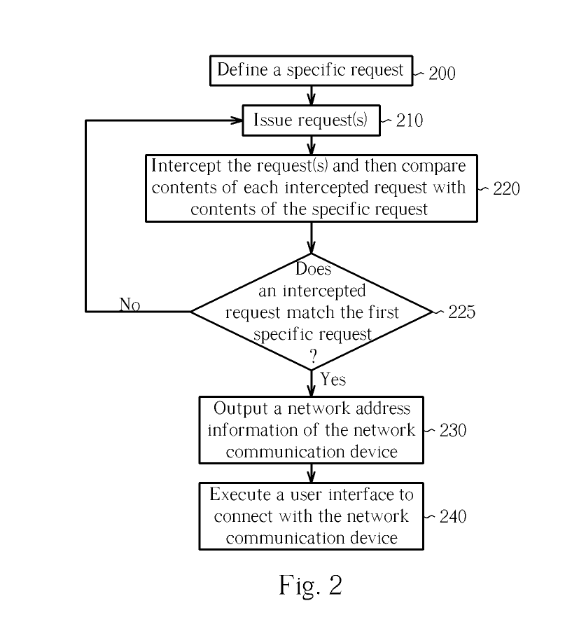

Please refer to FIG. 2 in conjunction with FIG. 1. FIG. 2 is a flowchart illustrating a method employed by the system 100 shown in FIG. 1 for accessing the network 10. The network 10 accessing method is summarized as follows:

Step 200: Define a specific request. The network communication device 110 is configured to output its network address information (e.g. the IP address) in response to the specific request. The definition of the specific request can be set to the network communication device 110 by any available means.

Step 210: Issue request(s). The network terminal 120 is capable of issuing the specific request to request the network address information of the network communication device 110.

Step 220: Intercept the request(s) and then compare contents of each intercepted request with contents of the specific request. The network communication device 110 is configured to intercept the requests from the network terminal 120 and compare contents of each received request with contents of the specific request.

Step 225: Does an intercepted request match the first specific request? If yes, go to step 230; otherwise, go to step 210.

Step 230: Output a network address information of the network communication device 110. The network communication device 110 outputs its network address information in response to the intercepted specific request.

Step 240: Execute a user interface to connect with the network communication device 110. The network terminal 120 executes a user interface utilizing the network address information to connect with the network communication device 110 for accessing the network 10.

In this embodiment, the specific request is a DNS query packet generated in response to a uniform resource locator (URL) address, for example, “myzywallp1.com”. The definition of this specific URL address is set in the network communication device 110. That is, the network communication device 110 sets the specific request (for example, “myzywallp1.com”) corresponding to the network address information (e.g. a preset IP address assigned to a local area network) of the network communication device 110 (step 200). The network terminal 120 executes a user interface (for example, a browser application, a telnet application, or an FTP application) for issuing request(s) including the above-mentioned specific request (e.g. a DNS query packet used for requesting an IP address assigned to the specific URL address “myzywallp1.com”). In this embodiment, when the specific URL address “myzywallp1.com” is entered or selected by the browser application, the telnet application, or the FTP application, the specific request is outputted from the network terminal 120 to the network communication device 110 (step 210). The network communication device 110 intercepts the incoming request(s) and compares contents of each intercepted request with the specific request (step 220). In this embodiment, the network communication device 110 is configured to intercept all of the incoming DNS query packets. If an intercepted request matches the specific request, meaning that the specific request has been outputted from the network terminal 120 to request the IP address of the network communication device 110, the network communication device 110 outputs the IP address thereof in response to the specific request (step 230). Finally, the network terminal 120 executes a user interface utilizing the IP address to connect with the network communication device 110 for accessing the network 10 (step 240). Please note that the management module 112 is responsible for intercepting and analyzing each DNS query packet received from the network terminal 120 and then outputting the network address information if the DNS query packet querying the above specific URL address is found. The intercepted DNS query packet that is not the specific packet is released to the network 10. Additionally, the management module 112 will bypass other packets to the network 10 without interfering with normal network access operations.

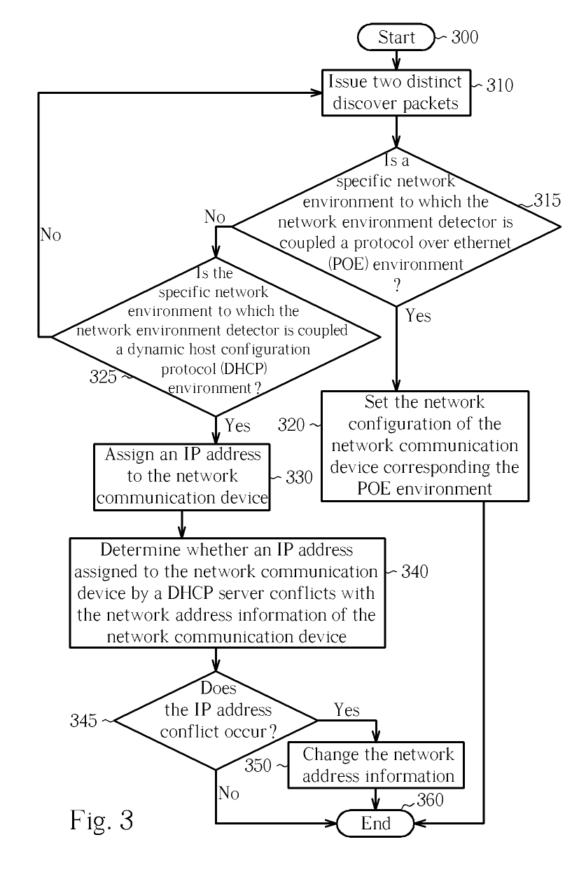

Please refer to FIG. 3 in conjunction with FIG. 1. FIG. 3 is a flowchart illustrating operation of configuring the network communication device 110. The network communication device 110 configuring is summarized as follows:

Step 300: Start.

Step 310: Issue two distinct discover packets. The network environment detector 114 issues a POE discover packet and a DHCP discover packet to detect whether the network communication device 110 is coupled to a POE network environment or a DHCP network environment before a network configuration of the network communication device 110 for communicating with the network 10 is accurately set.

Step 315: Is a specific network environment to which the network environment detector is coupled a protocol over ethernet (POE) environment? If yes, go to step 320; otherwise, go to step 325.

Step 320: Set the network configuration of the network communication device 110 corresponding to the POE environment. The network environment detector 114 informs the network terminal 120 of the detection result and then the network terminal sets the network configuration of the network communication device 110 corresponding to the POE environment. Go to step 360.

Step 325: Is the specific network environment to which the network environment detector is coupled a dynamic host configuration protocol (DHCP) environment? If yes, go to step 330; otherwise, go to step 340.

Step 330: Assign an IP address to the network communication device 110. The DHCP server (not shown) assigns an IP address to the network communication device 110.

Step 340: Determine whether an IP address assigned to the network communication device by a DHCP server conflicts with the network address information of the network communication device. The network communication device 110 determines whether an IP address (WAN IP address) assigned by a DHCP server conflicts with the network address information (LAN IP address) of the network communication device 110.

Step 345: Does the IP address conflict occur? If yes, go to step 350; otherwise, go to step 360.

Step 350: Change the network address information. The network communication device 110 automatically changes the network address information (i.e. the LAN IP address) to eliminate the IP address conflict.

Step 360: End.

Please note that the network terminal 120 connects with the network communication device 110 in a local area network (LAN), but the network communication device 110 connects with the network 10 in a wide area network (WAN). In this embodiment, the network environment detector 114 issues a POE discover packet and a DHCP discover packet to probe the network environment before a network configuration of the network communication device 110 for communicating with the network 10 is set (Step 310). If the network environment is the POE environment, a POE server connecting to the network 10 replies to the network environment detector 114. After receiving the response from the POE server, the network communication device 110 acknowledges that it is coupled to the POE environment. Next, a manual network configuration setting process is actuated for establishing a link between the network communication device 110 and the POE server. In this embodiment, the network terminal 120 executes a user interface utilizing the IP address of the network communication device 110 (i.e. the LAN IP address preset to the network communication device 110) to connect with the network communication device 110, for configuring the network configuration of the network communication device 110 corresponding to the POE environment (Step 320). On the other hand, if the network environment is the DHCP environment, a DHCP server connecting to the network 10 replies to the network environment detector 114, informing the network communication device 110 of the DHCP environment, and then assigns an IP address (i.e. a WAN IP address) to the network communication device 110 (Step 330). Moreover, if an IP address (i.e. a WAN IP address) assigned to the network communication device 110 by the DHCP server conflicts with the network address information (i.e. a LAN IP address) of the network communication device 110, the network communication device 110 is defined to automatically change the network address information (Step 350). It should be noted that after the IP address of the network communication device 110 is updated, the network environment detector 114 then assigns another IP address to the network terminal 120 according to the newly updated IP address (a LAN IP address) of the network communication device 110.

In summary, users only need to key in the preset DNS information (e.g. the specific URL address) to perform NSA network configuration and do not need to remember the IP address. Moreover, through the network environment detector, NSA will send POE and DHCP discover packets once the system is initiated. If there is a response from the DHCP discover packet, the NSA will take the current Internet environment as DHCP; in the same way, if there is a response from the POE packages, the NSA will take the current Internet environment as POE. In the DHCP environment, NSA will automatically get the network configuration and require no further user inputs. In the POE environment, users need to first connect the network terminal to NSA and key in the POE setting parameters to initiate POE once NSA pops up POE setting windows on a display screen of the network terminal. Please note that NSA of the present invention will detect Internet environment for users automatically, so that users can access the network more quickly and easily. In addition, if the WAN IP address assigned to NSA by the DHCP server conflicts with the LAN IP address internal setting of NSA, NSA will eliminate the conflict by changing its internal setting automatically.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for accessing a network, comprising:
a network communication device, coupled to the network, for communicating with the network, wherein the network communication device comprises a management module for outputting a network address information of the network communication device in response to a specific request.

2. The system of claim 1, wherein the network communication device is a network security appliance.

3. The system of claim 1, wherein the network is the Internet.

4. The system of claim 1, wherein the specific request is a DNS query packet.

5. The system of claim 4, further comprising:
a network terminal, coupled to the network communication device, for issuing the specific request to request the network address information of the network communication device and then utilizing the network address information of the network communication device to communicate with the network communication device for accessing the network.

6. The system of claim 5, wherein the network terminal outputs the DNS query packet according to a specific uniform resource locator (URL) address.

7. The system of claim 5, wherein the network terminal executes a user interface for receiving the specific URL address.

8. The system of claim 7, wherein the user interface is a browser application, a telnet application, or an FTP application.

9. The system of claim 5, wherein the management module analyzes each packet received from the network terminal, intercepts the DNS query packet and then outputs the network address information if the DNS query packet is found, and bypasses other packets to the network.

10. The system of claim 4, wherein the network communication device further comprises:
a network environment detector, coupled to the network terminal, for issuing at least a discover packet to detect if the network communication device is coupled to a specific network environment before a network configuration of the network communication device for communicating with the network is set.

11. The system of claim 10, wherein the discover packet is utilized for checking if the specific network environment is a protocol over ethernet (POE) environment; and if the network environment detector detects that the network communication device is coupled to the POE environment, the network communication device is assigned with the network configuration of the network communication device corresponding to the POE environment.

12. The system of claim 11, wherein the network environment detector informs the network terminal and then the network terminal sets the network configuration of the network communication device corresponding to the POE environment.

13. The system of claim 10, wherein the discover packet is utilized for checking if the specific network environment is a dynamic host configuration protocol (DHCP) environment; and if the network environment detector detects that the network communication device is coupled to the DHCP environment, the network communication device is assigned with the network configuration of the network communication device corresponding to the DHCP environment.

14. The system of claim 13, wherein the network environment detector informs the network terminal and then the network terminal sets the network configuration of the network communication device corresponding to the DHCP environment.

15. The system of claim 13, wherein if an IP address assigned to the network communication device by a DHCP server conflicts with the network address information of the network communication device, the network communication device automatically changes the network address information.

16. A system for setting a network configuration, the system comprising:
a network communication device, coupled to a network, for communicating with the network, the network communication device comprising:
a network environment detector, for issuing at least a discover packet to detect if the network communication device is coupled to a specific network environment before a
network configuration of the network communication device for communicating with the network is set.

17. The system of claim 16, wherein the discover packet is utilized for checking if the specific network environment is a protocol over ethernet (POE) environment; and if the network environment detector detects that the network communication device is coupled to the POE environment, the network communication device is assigned with the network configuration of the network communication device corresponding to the POE environment.

18. The system of claim 17, wherein the network environment detector informs a network terminal and then the network terminal sets the network configuration of the network communication device corresponding to the POE environment.

19. The system of claim 18, wherein the discover packet is utilized for checking if the specific network environment is a dynamic host configuration protocol (DHCP) environment; and if the network environment detector detects that the network communication device is coupled to the DHCP environment, the network communication device is assigned with the network configuration of the network communication device corresponding to the DHCP environment.

20. The system of claim 19, wherein the network environment detector informs the network terminal and then the network terminal sets the network configuration of the network communication device corresponding to the DHCP environment.

21. The system of claim 19, wherein if an IP address assigned to the network communication device by a DHCP server conflicts with the network address information of the network communication device, the network communication device automatically changes the network address information.

22. A method for configuring a system having a network communication device and a network terminal, the network terminal coupled to a network through the network communication device, the method comprising:
issuing a specific request to request a network address information of the network communication device;
utilizing the network communication device to output the network address information of the network communication device in response to the specific request; and
utilizing the network terminal to communicate with the network communication device for accessing the network according to the network address information of the network communication device.

23. The method of claim 22, wherein the network communication device is a network security appliance.

24. The system of claim 22, wherein the network is the Internet.

25. The method of claim 22, wherein the specific request is a DNS query packet.

26. The method of claim 25, further comprising:
outputting the DNS query packet according to a specific uniform resource locator (URL) address.

27. The method of claim 25, further comprising:
executing a user interface for receiving the specific URL address.

28. The method of claim 27, wherein the user interface is a browser application, a telnet application, or an FTP application.

29. The method of claim 25, further comprising:
analyzing each packet received from the network terminal;
intercepting the DNS query packet and then outputting the network address information if the DNS query packet is found; and
bypassing other packets to the network.

30. The method of claim 22, wherein the step of utilizing the network communication device to output the network address information of the network communication device in response to the specific request further comprises:
issuing at least a discover packet to detect if the network communication device is coupled to a specific network environment before a network configuration of the network communication device for communicating with the network is set.

31. The method of claim 30, further comprising:
utilizing the discover packet to check if the specific network environment is a protocol over ethernet (POE) environment; and
if the network communication device is coupled to the POE environment, assigning the network communication device with the network configuration of the network communication device corresponding to the POE environment.

32. The method of claim 31, further comprising:
informing the network terminal; and
setting the network configuration of the network communication device corresponding to the POE environment through the network terminal.

33. The method of claim 30, further comprising:
utilizing the discover packet to check if the specific network environment is a dynamic host configuration protocol (DHCP) environment; and
if the network communication device is coupled to the DHCP environment, assigning the network communication device with the network configuration of the network communication device corresponding to the DHCP environment.

34. The method of claim 33, further comprising:
informing the network terminal; and
setting the network configuration of the network communication device corresponding to the DHCP environment through the network terminal.

35. The method of claim 33, further comprising:
if an IP address assigned to the network communication device by a DHCP server conflicts with the network address information of the network communication device, automatically changing the network address information.

36. A method for setting a network configuration, comprising:
utilizing a network communication device to communicate with the network; and
utilizing a network environment detector for issuing at least a discover packet to detect if the network communication device is coupled to a specific network environment before a network configuration of the network communication device for communicating with the network is set.

37. The method of claim 36, further comprising:
utilizing the discover packet to check if the specific network environment is a protocol over ethernet (POE) environment; and
if the network communication device is coupled to the POE environment, assigning the network communication device with the network configuration of the network communication device corresponding to the POE environment.

38. The method of claim 37, further comprising:
informing a network terminal; and
setting the network configuration of the network communication device corresponding to the POE environment through the network terminal.

39. The method of claim 38, further comprising:
utilizing the discover packet to check if the specific network environment is a dynamic host configuration protocol (DHCP) environment; and
if the network communication device is coupled to the DHCP environment, assigning the network communication device with the network configuration of the network communication device corresponding to the DHCP environment.

40. The method of claim 39, further comprising:
informing the network terminal; and
setting the network configuration of the network communication device corresponding to the DHCP environment through the network terminal.

41. The method of claim 39, further comprising:
if an IP address assigned to the network communication device by a DHCP server conflicts with the network address information of the network communication device, automatically changing the network address information.
